(19) United States
(12) Patent Application Publication
(10) Pub. No.: US 2026/0019987 A1
(43) Pub. Date: Jan. 15, 2026

(54) DETERMINATION OF POSITIONING ANCHOR

(71) Applicant: Nokia Technologies Oy, Espoo (FI)

(72) Inventors: Diomidis MICHALOPOULOS, Munich (DE); Taylan SAHIN, Munich (DE); Stepan KUCERA, Munich (DE); Prajwal KESHAVAMURTHY, Munich (DE); Berthold PANZNER, Munich (DE)

(21) Appl. No.: 18/994,236

(22) PCT Filed: Jun. 29, 2023
(86) PCT No.: PCT/FI2023/050403

§ 371 Date: Jan. 14, 2025

(30) Foreign Application Priority Data
Jul. 26, 2022 (FI) 20225689

(51) Int. Cl. H04W 64/00; H04W 16/28; H04W 24/08

(52) U.S. Cl. CPC H04W 64/006; H04W 16/28; H04W 24/08

(57) ABSTRACT

Disclosed is a method comprising receiving, by an apparatus, a first set of information associated with one or more first beams of a network element; obtaining, by the apparatus, a second set of information associated with one or more second beams of the network element by performing beam-specific downlink measurements on the one or more second beams; and determining, by the apparatus, based at least partly on the first set of information and the second set of information, whether the apparatus is in a suitable location for acting as a positioning anchor for a target user device.

### FIELD

The following example embodiments relate to wireless communication and to positioning.

### BACKGROUND

Positioning technologies may be used to estimate a physical location of a user device. It is desirable to improve the positioning accuracy in order to estimate the location of the user device more accurately.

### BRIEF DESCRIPTION

The scope of protection sought for various example embodiments is set out by the claims. The example embodiments and features, if any, described in this specification that do not fall under the scope of the claims are to be interpreted as examples useful for understanding various embodiments.

According to an aspect, there is provided an apparatus comprising at least one processor, and at least one memory storing instructions which, when executed by the at least one processor, cause the apparatus at least to: receive a first set of information associated with one or more first beams of a network element; obtain a second set of information associated with one or more second beams of the network element by performing beam-specific downlink measurements on the one or more second beams; and determine, based at least partly on the first set of information and the second set of information, whether the apparatus is in a suitable location for acting as a positioning anchor for a target user device.

According to another aspect, there is provided an apparatus comprising: means for receiving a first set of information associated with one or more first beams of a network element; means for obtaining a second set of information associated with one or more second beams of the network element by performing beam-specific downlink measurements on the one or more second beams; and means for determining, based at least partly on the first set of information and the second set of information, whether the apparatus is in a suitable location for acting as a positioning anchor for a target user device.

According to another aspect, there is provided a method comprising: receiving, by an apparatus, a first set of information associated with one or more first beams of a network element; obtaining, by the apparatus, a second set of information associated with one or more second beams of the network element by performing beam-specific downlink measurements on the one or more second beams; and determining, by the apparatus, based at least partly on the first set of information and the second set of information, whether the apparatus is in a suitable location for acting as a positioning anchor for a target user device.

According to another aspect, there is provided a computer program comprising instructions which, when executed by an apparatus, cause the apparatus to perform at least the following: receiving a first set of information associated with one or more first beams of a network element; obtaining a second set of information associated with one or more second beams of the network element by performing beam-specific downlink measurements on the one or more second beams; and determining, based at least partly on the first set of information and the second set of information, whether the apparatus is in a suitable location for acting as a positioning anchor for a target user device.

According to another aspect, there is provided a computer readable medium comprising program instructions which, when executed by an apparatus, cause the apparatus to perform at least the following: receiving a first set of information associated with one or more first beams of a network element; obtaining a second set of information associated with one or more second beams of the network element by performing beam-specific downlink measurements on the one or more second beams; and determining, based at least partly on the first set of information and the second set of information, whether the apparatus is in a suitable location for acting as a positioning anchor for a target user device.

According to another aspect, there is provided a non-transitory computer readable medium comprising program instructions which, when executed by an apparatus, cause the apparatus to perform at least the following: receiving a first set of information associated with one or more first beams of a network element; obtaining a second set of information associated with one or more second beams of the network element by performing beam-specific downlink measurements on the one or more second beams; and determining, based at least partly on the first set of information and the second set of information, whether the apparatus is in a suitable location for acting as a positioning anchor for a target user device.

According to another aspect, there is provided an apparatus comprising at least one processor, and at least one memory storing instructions which, when executed by the at least one processor, cause the apparatus at least to: obtain a first set of information associated with one or more first beams of a network element by performing beam-specific downlink measurements on the one or more first beams; receive, from a candidate positioning anchor, a second set of information associated with one or more second beams of the network element; and determine, based at least partly on the first set of information and the second set of information, whether the candidate positioning anchor is in a suitable location for acting as a positioning anchor for the apparatus.

According to another aspect, there is provided an apparatus comprising: means for obtaining a first set of information associated with one or more first beams of a network element by performing beam-specific downlink measurements on the one or more first beams; means for receiving, from a candidate positioning anchor, a second set of information associated with one or more second beams of the network element; and means for determining, based at least partly on the first set of information and the second set of information, whether the candidate positioning anchor is in a suitable location for acting as a positioning anchor for the apparatus.

According to another aspect, there is provided a method comprising: obtaining, by an apparatus, a first set of information associated with one or more first beams of a network element by performing beam-specific downlink measurements on the one or more first beams; receiving, by the apparatus, from a candidate positioning anchor, a second set of information associated with one or more second beams of the network element; and determining, by the apparatus, based at least partly on the first set of information and the second set of information, whether the candidate positioning anchor is in a suitable location for acting as a positioning anchor for the apparatus.

According to another aspect, there is provided a computer program comprising instructions which, when executed by an apparatus, cause the apparatus to perform at least the following: obtaining a first set of information associated with one or more first beams of a network element by performing beam-specific downlink measurements on the one or more first beams; receiving, from a candidate positioning anchor, a second set of information associated with one or more second beams of the network element; and determining, based at least partly on the first set of information and the second set of information, whether the candidate positioning anchor is in a suitable location for acting as a positioning anchor for the apparatus.

According to another aspect, there is provided a computer readable medium comprising program instructions which, when executed by an apparatus, cause the apparatus to perform at least the following: obtaining a first set of information associated with one or more first beams of a network element by performing beam-specific downlink measurements on the one or more first beams; receiving, from a candidate positioning anchor, a second set of information associated with one or more second beams of the network element; and determining, based at least partly on the first set of information and the second set of information, whether the candidate positioning anchor is in a suitable location for acting as a positioning anchor for the apparatus.

According to another aspect, there is provided a non-transitory computer readable medium comprising program instructions which, when executed by an apparatus, cause the apparatus to perform at least the following: obtaining a first set of information associated with one or more first beams of a network element by performing beam-specific downlink measurements on the one or more first beams; receiving, from a candidate positioning anchor, a second set of information associated with one or more second beams of the network element; and determining, based at least partly on the first set of information and the second set of information, whether the candidate positioning anchor is in a suitable location for acting as a positioning anchor for the apparatus.

### LIST OF DRAWINGS

In the following, various example embodiments will be described in greater detail with reference to the accompanying drawings, in which

FIG. 1 illustrates an example of a cellular communication network;

FIG. 2 illustrates three different examples of geometric dilution of precision;

FIG. 3 illustrates an example scenario for a target user device selecting suitable anchor node(s);

FIG. 4 illustrates an example of selecting suitable anchor node(s) according to an example embodiment;

FIG. 5 illustrates a signaling diagram according to an example embodiment;

FIG. 6 illustrates a signaling diagram according to an example embodiment;

FIG. 7 illustrates a signaling diagram according to an example embodiment;

FIG. 8 illustrates a signaling diagram according to an example embodiment;

FIG. 9 illustrates a signaling diagram according to an example embodiment;

FIG. 10 illustrates a flow chart according to an example embodiment;

FIG. 11 illustrates a flow chart according to an example embodiment;

FIG. 12 illustrates a flow chart according to an example embodiment;

FIG. 13 illustrates a flow chart according to an example embodiment; and

FIG. 14 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using, as an example of an access architecture to which the example embodiments may be applied, a radio access architecture based on long term evolution advanced (LTE Advanced, LTE-A), new radio (NR, 5G), beyond 5G, or sixth generation (6G) without restricting the example embodiments to such an architecture, however. It is obvious for a person skilled in the art that the example embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

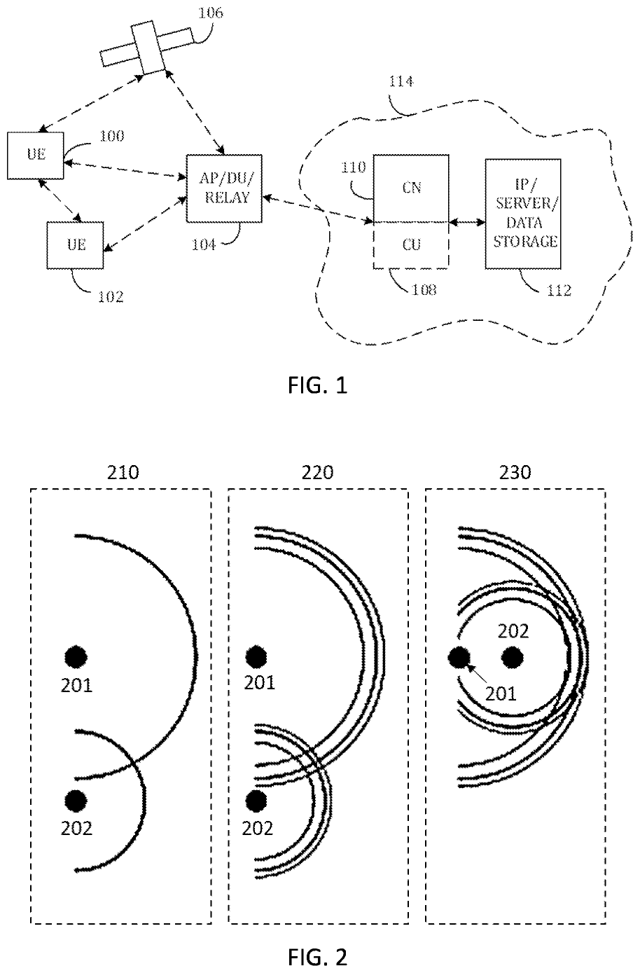

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The example embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a radio cell with an access node 104, such as an evolved Node B (abbreviated as eNB or eNodeB) or a next generation Node B (abbreviated as gNB or gNodeB), providing the radio cell. The physical link from a user device to an access node may be called uplink (UL) or reverse link, and the physical link from the access node to the user device may be called downlink (DL) or forward link. A user device may also communicate directly with another user device via sidelink (SL) communication. It should be appreciated that access nodes or their functionalities may be implemented by using any node, host, server or access point etc. entity suitable for such a usage.

A communication system may comprise more than one access node, in which case the access nodes may also be configured to communicate with one another over links, wired or wireless, designed for the purpose. These links may be used for signaling purposes. The access node may be a computing device configured to control the radio resources of communication system it is coupled to. The access node may also be referred to as a base station, a base transceiver station (BTS), an access point or any other type of interfacing device including a relay station capable of operating in a wireless environment. The access node may include or be coupled to transceivers. From the transceivers of the access node, a connection may be provided to an antenna unit that establishes bi-directional radio links to user devices. The antenna unit may comprise a plurality of antennas or antenna elements. The access node may further be connected to a core network 110 (CN or next generation core NGC). Depending on the system, the counterpart on the CN side may be a serving gateway (S-GW, routing and forwarding user data packets), packet data network gateway (P-GW) for providing connectivity of user devices to external packet data networks, user plane function (UPF), mobility management entity (MME), access and mobility management function (AMF), or location management function (LMF), etc.

The user device illustrates one type of an apparatus to which resources on the air interface may be allocated and assigned, and thus any feature described herein with a user device may be implemented with a corresponding apparatus, such as a relay node.

An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access node and forward it to a user device, and/or amplify a signal received from the user device and forward it to the access node.

The user device may also be called a subscriber unit, mobile station, remote terminal, access terminal, user terminal, terminal device, or user equipment (UE) just to mention but a few names or apparatuses. The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, reduced capability (RedCap) device, wireless sensor device, or any device integrated in a vehicle.

It should be appreciated that a user device may also be a nearly exclusive uplink-only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud or in another user device. The user device (or in some example embodiments a layer 3 relay node) may be configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may have multiple radio interfaces, namely below 6 GHZ, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave-mmWave). One of the concepts considered to be used in 5G networks may be network slicing, in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or an access node comprising radio parts. It may also be possible that node operations are distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and access node operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the access node. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). At least one satellite 106 in the mega-constellation may cover several satellite-enabled network entities that create on-ground cells. The on-ground cells may be created through an on-ground relay node 104 or by a gNB located on-ground or in a satellite.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

It is obvious for a person skilled in the art that the depicted system is only an example of a part of a radio access system and in practice, the system may comprise a plurality of access nodes, the user device may have access to a plurality of radio cells and the system may also comprise other apparatuses, such as physical layer relay nodes or other network elements, etc. At least one of the access nodes may be a Home eNodeB or a Home gNodeB.

Furthermore, the access node may also be split into: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) (also known as a centralized unit) that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the access node. The DU may be defined as a logical node hosting radio link control (RLC), medium access control (MAC) and/or physical (PHY) layers of the access node. The operation of the DU may be at least partly controlled by the CU. The CU may comprise a control plane (CU-CP), which may be defined as a logical node hosting the RRC and the control plane part of the PDCP protocol of the CU for the access node. The CU may further comprise a user plane (CU-UP), which may be defined as a logical node hosting the user plane part of the PDCP protocol and the SDAP protocol of the CU for the access node.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned access node units, or different core network operations and access node operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1 may provide any kind of these cells. A cellular radio system may be implemented as a multilayer network including several kinds of radio cells. In multilayer networks, one access node may provide one kind of a radio cell or radio cells, and thus a plurality of access nodes may be needed to provide such a network structure.

For fulfilling the need for improving the deployment and performance of communication systems, the concept of “plug-and-play” access nodes may be introduced. A network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's network, may aggregate traffic from a large number of Home eNodeBs or Home gNodeBs back to a core network.

Positioning technologies may be used to estimate a physical location of a user device. Herein the user device to be positioned is referred to as a target UE. For example, the following positioning techniques may be used in NR: downlink time difference of arrival (DL-TDoA), uplink time difference of arrival (UL-TDoA), downlink angle of departure (DL-AoD), uplink angle of arrival (UL-AoA), and/or multi-cell round trip time (multi-RTT).

In wireless positioning, multiple positioning anchors in known locations may transmit and/or receive one or more positioning reference signals (PRS) to/from the target UE. For example, multilateration techniques may then be used to localize (i.e., position) the target UE with respect to the positioning anchors. The positioning anchors may also be referred to as anchors, anchor nodes, multilateration anchors, or reference points herein. The positioning anchors may be, for example, radio access nodes (in uplink/downlink positioning) or other UEs (in sidelink positioning). At least three positioning anchors may be needed to position the target UE, but the positioning accuracy may be improved by using a higher number of positioning anchors (e.g., five to ten positioning anchors).

Sidelink (SL) positioning refers to the positioning approach, where the target UE utilizes the sidelink (i.e., the direct device-to-device link) to position itself, either in an absolute manner (in case of absolute positioning, where the coordinates of the target UE are obtained in the form of global or local Cartesian coordinates) or in a relative manner (in case of relative positioning, where the location of the target UE is estimated with respect to another entity, for example another non-static UE).

Sidelink positioning involves the use of a supporting UE or a set of supporting UEs, referred to as the “anchor UE(s)”, which assist(s) the positioning session of the target UE. The anchor UE support can be implemented in various ways, including the anchor UE(s) estimating the location of the target UE, target UE obtaining positioning assistance data by the anchor UE(s), etc., and the target UE measuring reference signals from the anchor UE(s) (or vice versa) for positioning purposes.

Some example embodiments relate to the last identified means of anchor UE(s) supporting the target UE in sidelink positioning, namely the case where the target UE measures reference signals from the anchor UE(s) (or vice versa) for positioning purposes. In an example scenario, a mobile target UE needs to be positioned, but there are not enough static gNBs or transmission and reception points (TRPs) transmitting and/or receiving positioning reference signals. Thus, one or more other mobile devices (anchor UEs) may need to be recruited to act as a positioning anchor for the target UE. In such a case, the anchor UE(s) may transmit sidelink positioning reference signals (SL-PRS) in the sidelink towards the target UE, and/or receive SL-PRS from the target UE.

Considering the above information, where an anchor UE or a set of anchor UEs is recruited to assist the positioning of at least one target UE via sidelink, the problem that arises is how to select the optimal set of anchor UE(s). This problem may especially affect distributed settings, where no network support is available (e.g., out-of-coverage UEs in SL autonomous resource selection mode).

The anchor UE candidates may need to satisfy a set of criteria before being selected as positioning anchors. These criteria may comprise, for example, resource availability, energy supply, interference, and/or relative location.

The accuracy of the positioning estimation depends on the relative location of the anchor UEs, both with respect to each other and with respect to the target UE. This impact, referred to as geometric dilution of precision (GDOP), is illustrated in FIG. 2.

FIG. 2 illustrates three different examples 210, 220, 230 of GDOP. Assuming that two anchor nodes 201, 202 are used for positioning a target UE, and utilizing a ranging technique, the accuracy in the probable location of the target UE decreases as the geometry of the anchor node and the target UE moves away from forming a triangle (as in block 220 with low GDOP), and rather becoming co-linear with high GDOP (as in block 230).

In block 210, the distance to two landmarks has been measured, and their point has been measured as the intersection of two circles with the measured radius. In block 220, the measurement has some error bounds, and their true location may lie anywhere in the area where the various circles intersect. In block 230, the measurement error may be the same as in block 220, but the error on their position (i.e., the area where the circles intersect) has grown considerably due to the arrangement of the landmarks.

Therefore, in cases where there are not enough gNBs/TRPs for the positioning of the target UE, the target UE may need to consider the (approximate) location of the candidate anchor node with respect to its own location, before selecting the anchor node(s) in the positioning process. Given that the target UE is not aware of its own location before the positioning session starts, the target UE cannot simply request for the absolute location information of the candidate anchor nodes, since this would not be of any (apparent) use to the target UE. Instead, the target UE may consider the relative location information of the candidate anchor nodes with respect to the target UE and the static gNBs/TRPs. Herein the term “candidate anchor node” refers to a potential anchor node that is not yet acting as an anchor node, however. The candidate anchor node of the embodiments may be a UE or a gNB, and the embodiments hereinafter are explained when the candidate anchor node is a UE. However, the embodiments can be also applied when the candidate anchor node is a gNB.

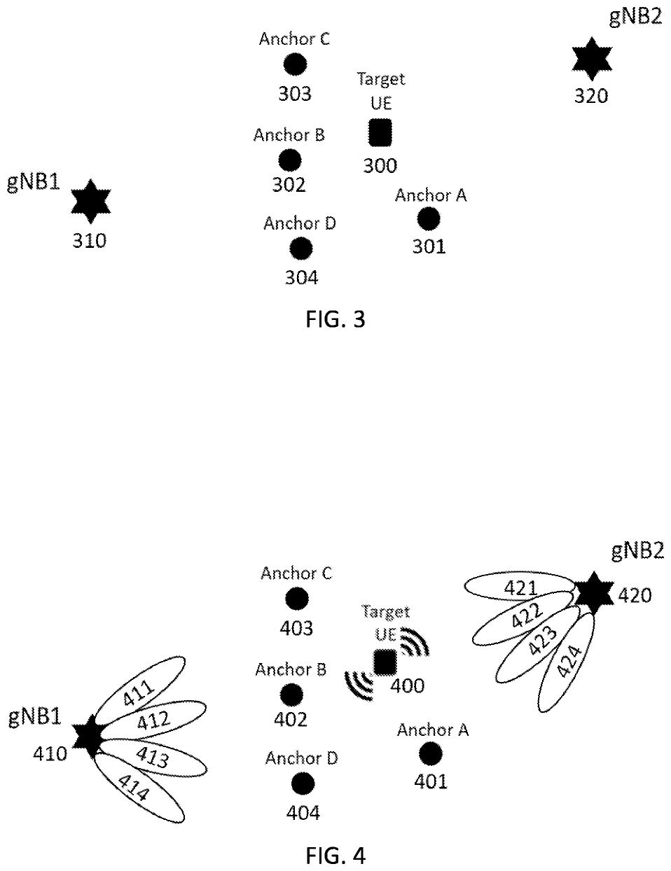

FIG. 3 illustrates an example scenario for a target UE 300 selecting suitable anchor node(s). In this example scenario, the target UE 300 is using a first gNB 310 and a second gNB 320 as positioning anchors of its positioning session (i.e., the target UE measures PRS from the first gNB and the second gNB). However, the target UE 300 needs additional positioning anchor nodes to complete its positioning (when two gNBs are not enough), and hence it needs to activate additional anchor node(s) for this purpose. The target UE 300 considers the relative location information of the candidate anchors A, B, C, and D (301, 302, 303, 304) for assessing their suitability to act as anchor nodes under the role of additional positioning anchors.

In this example, Anchor B 302 would not be suitable, since its relative location yields high GDOP. The reason for this is that Anchor B is located in between the target UE and at least one TRP (gNB1 in this example). Hence, if selected, Anchor B would result in low positioning accuracy. On the other hand, Anchor C 303, Anchor D 304, and Anchor A 301 have a suitable relative location that would lead to higher positioning accuracy. However, the target UE does not have any prior knowledge on the relative location of the candidate anchor nodes (for example, it cannot tell whether Anchor B is in between gNB1 and the target UE). Thus, a “blind” activation of Anchor B would lead to positioning performance degradation.

In an example embodiment, the target UE may obtain relative location information of the candidate anchor UE(s), so as to assess their suitability to be anchor UEs. This way, the target UE may select the anchor UE(s) that have a low level of co-linearity with respect to the target UE.

Some example embodiments are described below using principles and terminology of 5G technology without limiting the example embodiments to 5G communication systems, however.

Some example embodiments are based on the principle that candidate anchor nodes can identify whether they are in a suitable relative location with respect to the target UE and at least one gNB or not, based on their DL measurements of gNB beams and their relation to the same measurements conducted at the target UE. In an example embodiment, the target UE broadcasts its DL (gNB-specific and beam-specific) measurements via sidelink, which are used by candidate anchor node(s) to assess whether they are in a suitable relative location to the target UE.

The target UE may collect the DL measurements in a similar way as DL-AoD measurements are collected. However, in contrast to DL-AoD positioning, the target UE may broadcast the information on DL-AoD measurements in the sidelink (instead of reporting them to the network), for the purpose of identifying suitable anchor UEs for positioning using sidelink.

FIG. 4 illustrates an example of selecting suitable anchor node(s) according to an example embodiment. In this example, a target UE 400 is using a first gNB 410 and a second gNB 420 as positioning anchors of its positioning session (i.e., the target UE measures PRS from the first gNB and the second gNB). However, the target UE 400 needs additional positioning anchors to complete its positioning (when two gNBs are not enough), and hence it needs to activate anchor node(s) for this purpose. The target UE 400 broadcasts beam-specific DL measurements, and candidate anchor nodes 401, 402, 403, and 404 declare their suitability based on a comparison of their own measurements to that of the target UE.

Referring to FIG. 4, the target UE 400 may measure, for example, a first reference signal received power (RSRP) level of a second beam 412 of the first gNB 410, a first RSRP level of a second beam 422 of the second gNB 420, a second RSRP level of a first beam 411 of the first gNB 410, and a second RSRP level of a first beam 421 of the second gNB 420 as part of DL-AoD measurements.

The target UE 400 may broadcast the above measurements (e.g., the unprocessed RSRP measurements or the processed AoD information) in the sidelink for example: a) as part of the request for anchor UE, or b) together with one or more threshold values indicating whether a candidate anchor UE should declare suitability when compared to the candidate anchor UE's own measurements, such as based on a threshold or range associated with the measurements.

The candidate anchor nodes 401, 402, 403, 404 may process the (gNB-specific and beam-specific) measurement information broadcasted by the target UE 400 and compare it with their own measurements. In this example, in case of Anchor node A 401, Anchor node C 403, and Anchor node D 404, their DL-AoD beam measurements result in substantially different relation of the RSRP levels of beams as that of the target UE 400. For example, Anchor node A 401 may measure the second beam 412 of the first gNB 410 and the second beam 422 of the second gNB 420 at an RSRP level, which is substantially lower than that of the target UE 400, while Anchor node A 401 additionally measures the second RSRP level of the third beam 413 of the first gNB 410 and the first RSRP level of the third beam 423 of the second gNB 420. This is an indication for Anchor node A 401 that it is not located between the target UE 400 and any gNB 410, 420, and hence Anchor node A 401 may declare itself as a suitable positioning anchor for the target UE 400. The same applies for Anchor node C 403 and Anchor node D 404.

On the other hand, Anchor node B 402 measures the second beam 412 of the first gNB 410, the second beam 422 of the second gNB 420, the first beam 411 of the first gNB 410, and the first beam 421 of the second gNB 420 at a similar RSRP level (within configured thresholds) as the target UE 400, and hence non-suitability is inferred. As a result, Anchor node B 402 backs off from being a positioning anchor of the target UE 400 (e.g., does not transmit SL-PRS), and may declare itself as a non-suitable positioning anchor due to the non-suitable relative location between the target UE 400 and the first gNB 410.

Herein the term “beam” may refer to a communication resource. Different beams may be considered as different resources. A beam may also be represented as a spatial filter, spatial direction, or angle. A technology for forming a beam may be a beamforming technology or another technology. The beamforming technology may be specifically a digital beamforming technology, analog beamforming technology, or a hybrid digital/analog beamforming technology. A communication device (e.g., UE or gNB) may communicate with another communication device through one or more beams. One beam may include one or more antenna ports and be configured for a data channel, a control channel, or the like. The one or more antenna ports forming one beam may also be considered as an antenna port set. A beam may be configured with a set of resources, or a set of resources for measurement. One example is a synchronization signal block (SSB) resource configuration and/or a channel state information (CSI) resource configuration, which may include a CSI-ResourceConfigId and channel state information reference signal (CSI-RS) resource set.

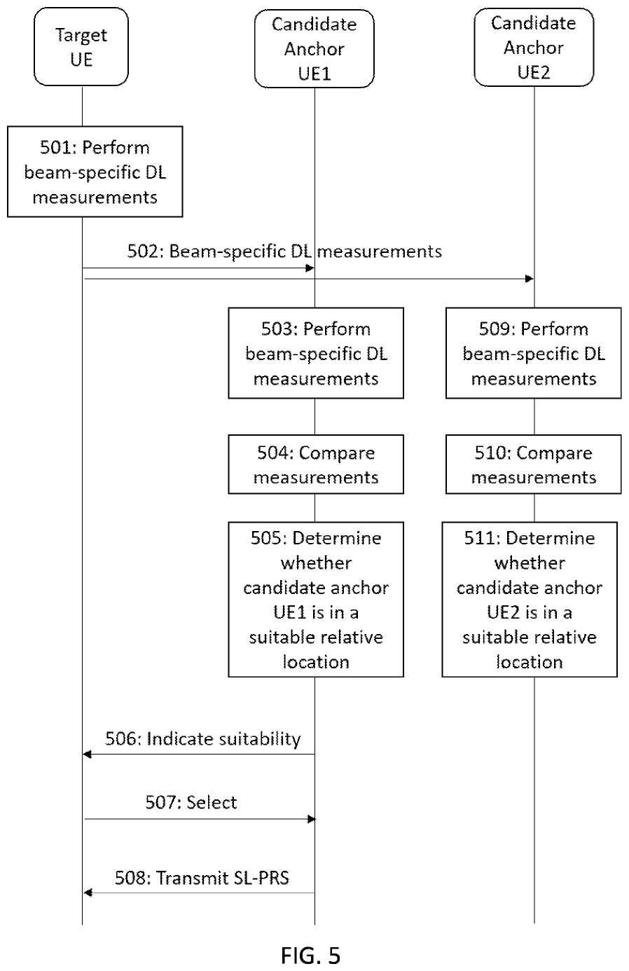

FIG. 5 illustrates a signaling diagram according to an example embodiment, wherein a target UE broadcasts its own DL measurements (unprocessed gNB-specific and beam-specific measurements), letting candidate anchor UEs decide whether they are in a suitable location for acting as a positioning anchor for the target UE

Although two candidate anchor UEs are shown in FIG. 5, it should be noted that the number candidate anchor UEs may also be different than two. In other words, there may be one or more candidate anchor UEs. In addition, the signaling procedure illustrated in FIG. 5 may be extended and applied according to the actual number of candidate anchor UEs.

Referring to FIG. 5, in block 501, the target UE performs beam-specific downlink measurements, for example RSRP measurements, on one or more first beams of a network element to obtain a first set of information associated with the one or more first beams of the network element. In other words, the first set of information may comprise first beam-specific downlink measurement information, for example RSRP measurement information, associated with the one or more first beams of the network element. The network element may be, for example, a base station such as a gNB or a TRP that is acting as a positioning anchor for the target UE. The one or more first beams mean one or more beams that are received by the target UE.

In block 502, the target UE transmits, or broadcasts, the first set of information comprising the first beam-specific DL measurement information to a first candidate anchor UE and to a second candidate anchor UE via sidelink. The first candidate anchor UE and the second candidate anchor UE receive the first set of information from the target UE via sidelink.

For example, the target UE may transmit the first set of information in an anchor UE request message, which indicates a request for a positioning anchor. Such a combined message may increase resource efficiency in order to efficiently indicate the anchor UE request to the candidate anchor UEs, while also indicating (indirectly) where the anchor UEs should be located.

The target UE may also indicate one or more threshold values used for a comparison between the target UE measurements and the candidate anchor UE measurements. That is, the target UE may indicate in the SL broadcasted signal, for example together with the first beam-specific DL measurements, the acceptable range that the candidate anchor UEs should consider for flagging themselves in a suitable or unsuitable location, based on the comparison to the candidate anchor UE's own measurements and ranging estimation between the target UE and the candidate anchor UE (e.g., based on SL RSRP measurements). The comparison between the beam-specific DL measurements (or comparison on AoD) may lead to some difference in the angular domain. For example, in case the difference is approximately 10 degrees, this 10-degree difference may or may not be sufficient depending on: a) on the distance between the devices (candidate anchor UE to target UE), and the performance requirements. This corresponds to a range of angular values that are acceptable (e.g., −15 deg to +15 deg difference). The one or more threshold values can be configured by the target UE or by the network.

Alternatively, or additionally, the target UE may transmit information on one or more location zones to the candidate anchor UEs together with the first set of information (or separately from the first set of information) to help the candidate anchor UEs determine whether they are in a suitable location relative to the target UE. For example, the target UE may define one or more exclusion and/or inclusion zones, which are absolute location zones on the basis of the target UE's absolute location and the exclusion (or inclusion) areas not favorable (or favorable) for other UEs to be selected as anchor UEs of the target UE. In this case, the network may also (pre-) configure such exclusion and/or inclusion zones for the target UE and/or for the candidate anchor UEs. For example, the network may define the exclusion zone(s) relative to the latest location of the target UE.

If a given candidate anchor UE is inside an exclusion zone, then it means that the candidate anchor UE is not in a suitable location relative to the target UE. On the other hand, if the candidate anchor UE is inside an inclusion zone, then it means that the candidate anchor UE is in a suitable location relative to the target UE.

For example, there may be some location zones around the target UE, such that candidate anchor UEs who happen to reside within one of those zones correspond to relative AoD information that yields unsuitable anchor UEs. Looking at FIG. 4, for example, the area around the target UE 400 where the beams 412, 422 (i.e., the second beam from gNB1 and the second beam from gNB2) are strongest would be an exclusion zone. The exclusion zone may be defined as an AoD range measured from the gNB(s). As a non-limiting example, if the candidate anchor UE measures an AoD from gNB1 to be between 15-25 degrees, and an AoD from gNB2 to be between 35-45 degrees, then the candidate anchor UE may be in the exclusion zone (i.e., unsuitable location). In a similar way, inclusion zones can be defined for example in areas where the beams 412, 422 are weaker. These zones may be adjusted dynamically as the target UE moves.

In block 503, the first candidate anchor UE performs its own beam-specific downlink measurements, for example RSRP measurements, on one or more second beams of the network element to obtain a second set of information associated with the one or more second beams of the network element. In other words, the second set of information may comprise second beam-specific downlink measurement information, for example RSRP measurement information, associated with the one or more second beams of the network element. The one or more second beams mean one or more beams that are received by the first candidate anchor UE. The one or more second beams may be part of the one or more first beams, or the one or more second beams may be different than the one or more first beams. The one or more first beams and the one or more second beams may be transmitted from the same network element.

In block 504, the first candidate anchor UE compares the first set of information perceived at the target UE and the second set of information perceived at the first candidate anchor UE.

For example, the first candidate anchor UE may infer whether it is located in the middle between the network element and the target UE (without extracting AoD information from the measurements). As a result, the first candidate anchor UE may estimate the level of GDOP and infer whether it is in a suitable location relative to the target UE.

Alternatively, the first candidate anchor UE may extract, or derive, first AoD information from the first beam-specific downlink measurement information (received from the target UE) associated with the one or more first beams of the network element. The first candidate anchor UE may also extract, or derive, second AoD information based on its own beam-specific DL measurements, i.e., from the second beam-specific downlink measurement information associated with the one or more second beams of the network element (i.e., with respect to the same network element as the first AoD information). The AoD information may be extracted by translating the different RSRP levels per beam into the direction of the transmit signal from the network element. The first candidate anchor UE may compare the AoD information of the target UE and its own AoD information for the network element. This alternative may be applied, for example, when the first candidate anchor UE is in UE-based positioning mode, such that the first candidate anchor UE is also able to estimate its own AoD with respect to the network element. In such a case, the first candidate anchor UE may receive, from the network element, location calculation assistance information which allows the first candidate anchor UE to interpret beam-specific DL measurements into DL-AoD information.

In block 505, based on the comparison of the first beam-specific downlink measurement information and the second beam-specific downlink measurement information, or the comparison of the first AoD information and the second AoD information, the first candidate anchor UE determines whether it is in a suitable location relative to the target UE for acting as a positioning anchor for the target UE.

The determination may also be based at least partly on the one or more threshold values that may be received from the target UE or from the network element. Alternatively, or additionally, the determination may be based at least partly on the one or more location zones that may be defined by the target UE or by the network.

In block 506, the first candidate anchor UE may transmit an indication to the target UE to indicate whether the first candidate anchor UE is a suitable anchor UE and/or is in the suitable location for acting as a positioning anchor for the target UE. For example, in case the first candidate anchor UE received an anchor UE request message (e.g., in block 502) from the target UE, then the first candidate anchor UE may transmit a response message in response to the anchor UE request message, wherein the response message indicates whether the first candidate anchor UE is a suitable anchor UE and/or in the suitable location.

The response message may further comprise the second set of information (e.g., the second beam-specific downlink measurement information or the second AoD information based on its own measurements). This way, the responding candidate anchor UE may include its own beam-specific DL measurements or AoD information as additional information in its response message, so that other candidate anchor UE(s) in the same area may inhibit from responding. This reduces the possibility of multiple candidate anchor UEs residing in each others' vicinity, when responding to the request. This may be beneficial, for example, when all the candidate anchor UEs do not respond simultaneously.

The block 506 may be performed by all of the candidate anchor UEs that received the anchor UE request message or the first set of information from the target UE.

In block 507, the target UE may select the first candidate anchor UE among the candidate anchor UEs as a positioning anchor (in case the first candidate anchor UE indicated that it is in a suitable location). And then, the target UE may transmit an indication to the first candidate anchor UE for activating it as a positioning anchor for the target UE. If there are multiple suitable candidate anchor UEs, the target UE may select one or more of them based on its positioning requirements. If the positioning requirements are high, the target UE may activate all of the available candidate anchor UEs. Otherwise, the target UE may downselect the available candidate anchor UEs.

In block 508, in response to being selected/activated as a positioning anchor for the target UE, the first candidate anchor UE may start broadcasting one or more sidelink positioning reference signals for assisting in positioning the target UE. Alternatively, the first candidate anchor UE may autonomously start broadcasting SL-PRS in response to determining that it is in the suitable location (i.e., without being separately selected by the target UE).

In case the first candidate anchor UE transmits SL-PRS for positioning the target UE, the first candidate anchor UE may also configure the directivity of the SL-PRS based on the first beam-specific DL measurement information it receives from the target UE (or based on the first AoD information). This means that the first candidate anchor UE would not transmit SL PRS in all directions (in an omni-directional fashion), but rather toward the direction(s) that are defined based on the outcome of the processing of the information transmitted by the target UE. In other words, the first candidate anchor UE may transmit the one or more sidelink positioning reference signal in one or more directions, wherein the one or more directions may be based on the first set of information received from the target UE. Herein the term “direction” may refer to a spatial direction or angle.

In block 509, the second candidate anchor UE performs its own beam-specific downlink measurements, for example RSRP measurements, on one or more third beams of the network element to obtain a third set of information associated with the one or more third beams of the network element. In other words, the third set of information may comprise third beam-specific downlink measurement information, for example RSRP measurement information, associated with the one or more third beams of the network element. The one or more third beams mean one or more beams that are received by the second candidate anchor UE. The one or more third beams may be part of the one or more first beams, or the one or more second beams may be different than the one or more first beams. The one or more first beams and the one or more third beams may be transmitted from the same network element.

In block 510, the second candidate anchor UE compares the first set of information perceived at the target UE and the third set of information perceived at the second candidate anchor UE similarly as described above for block 504.

In block 511, based on the comparison of the unprocessed beam-specific DL measurements or the processed AoD information of the target UE and the second candidate anchor UE, the second candidate anchor UE determines whether it is in a suitable location relative to the target UE and the network element for acting as a positioning anchor for the target UE.

The determination may also be based at least partly on the one or more threshold values that may be received from the target UE or from the network. Alternatively, or additionally, the determination may be based at least partly on the one or more location zones that may be defined by the target UE or by the network.

In case the second candidate anchor UE determines that it is a non-suitable anchor UE or in a non-suitable location, the second candidate anchor UE backs off from transmitting SL-PRS, and declares itself as a non-suitable anchor UEs. In this case, the second candidate anchor UE may explicitly indicate the non-suitability for example by means of a response message transmitted in response to the anchor UE request message that may be received from the target UE. Alternatively, the second candidate anchor UE may implicitly indicate the non-suitability for example by not responding to the anchor UE request message that may be received from the target UE.

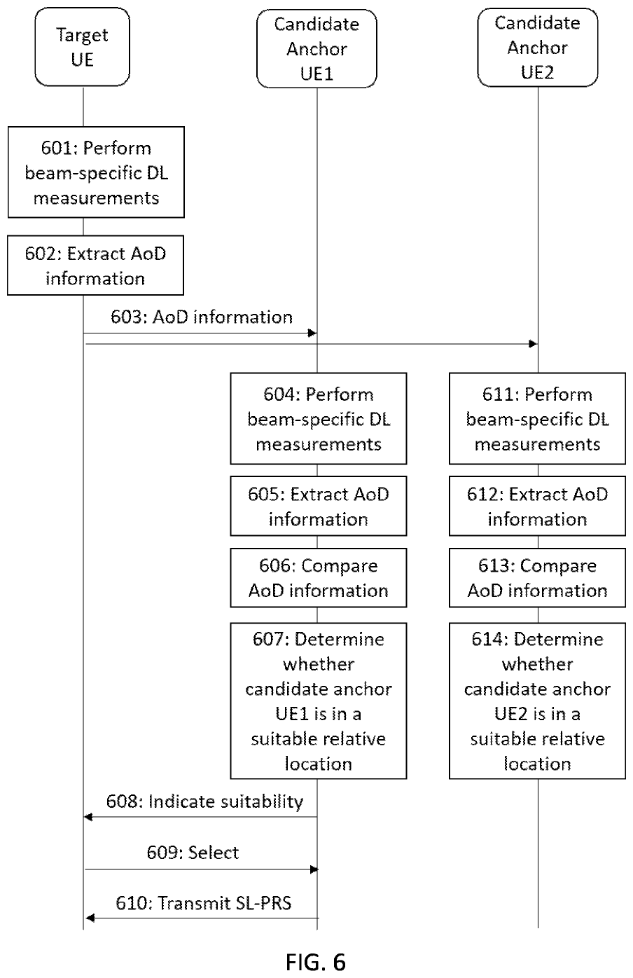

FIG. 6 illustrates a signaling diagram according to another example embodiment, wherein a target UE processes the beam-specific RSRP measurements and extracts AoD information with respect to one or more gNBs. The target UE then broadcasts its processed AoD information via sidelink. This example embodiment applies, for example, to the case where the target UE is in UE-based positioning mode.

Although two candidate anchor UEs are shown in FIG. 6, it should be noted that the number candidate anchor UEs may also be different than two. In other words, there may be one or more candidate anchor UEs. In addition, the signaling procedure illustrated in FIG. 6 may be extended and applied according to the actual number of candidate anchor UEs.

Referring to FIG. 6, in block 601, the target UE performs beam-specific downlink measurements, for example RSRP measurements, on one or more first beams of a network element to obtain first beam-specific downlink measurement associated with the one or more first beams of the network element. The network element may be, for example, a base station such as a gNB or a TRP that is acting as a positioning anchor for the target UE. The one or more first beams mean one or more beams that are received by the target UE. The one or more first beams and the one or more second beams may be transmitted from the same network element.

In block 602, the target UE extracts, or derives, first AoD information from the first beam-specific downlink measurement information associated with the one or more first beams of the network element. The first AoD information may be extracted by translating the different RSRP levels per beam into the direction of the transmit signal from the network element.

In block 603, the target UE transmits, or broadcasts, a first set of information comprising the first AoD information to a first candidate anchor UE and to a second candidate anchor UE via sidelink. The first candidate anchor UE and the second candidate anchor UE receive the first set of information from the target UE via sidelink.

For example, the target UE may transmit the first set of information in an anchor UE request message, which indicates a request for a positioning anchor. Such a combined message may increase resource efficiency in order to efficiently indicate the anchor UE request to the candidate anchor UEs, while also indicating (indirectly) where the anchor UEs should be located.

The target UE may also indicate one or more threshold values for a comparison between the first AoD information (as perceived at the target UE) and the AoD information perceived at a given candidate anchor UE. That is, the target UE may indicate in the SL broadcasted signal, for example together with the first AoD information, the acceptable range that the candidate anchor UEs should consider for flagging themselves in a suitable or unsuitable location, based on the comparison to the candidate anchor UE's own measurements and ranging estimation between the target UE and the candidate anchor UE.

Alternatively, or additionally, the target UE may transmit information on one or more location zones to the candidate anchor UEs together with the first set of information (or separately from the first set of information) to help the candidate anchor UEs determine whether they are in a suitable location relative to the target UE. For example, the target UE may define one or more exclusion and/or inclusion zones, which are absolute location zones on the basis of the target UE's absolute location and the exclusion (or inclusion) areas not favorable (or favorable) for other UEs to be selected as anchor UEs of the target UE. In this case, the network may also (pre-)configure such exclusion and/or inclusion zones for the target UE and/or for the candidate anchor UEs. For example, the network may define the exclusion zone(s) relative to the latest location of the target UE.

In block 604, the first candidate anchor UE performs its own beam-specific downlink measurements, for example RSRP measurements, on one or more second beams of the network element to obtain second beam-specific downlink measurement information associated with the one or more second beams of the network element. The one or more second beams mean one or more beams that are received by the first candidate anchor UE. The one or more second beams may be part of the one or more first beams, or the one or more second beams may be different than the one or more first beams.

In block 605, the first candidate anchor UE extracts, or derives, second AoD information from the second beam-specific downlink measurement information associated with the one or more second beams of the network element. The second AoD information may be extracted by translating the different RSRP levels per beam into the direction of the transmit signal from the network element.

In block 606, the first candidate anchor UE compares the first AoD information perceived at the target UE and the second AoD information perceived at the first candidate anchor UE.

In block 607, based on the comparison of the first AoD information and the second AoD information, the first candidate anchor UE determines whether it is a suitable anchor UE or in a suitable location relative to the target UE and the network element for acting as a positioning anchor for the target UE.

The determination may also be based at least partly on the one or more threshold values that may be received from the target UE or from the network. For example, the first candidate anchor UE may check whether the difference between the first AoD information and the second AoD information is outside the range defined by the one or more threshold values. The first AoD information refers to the AoD between the network element and the target UE, and the second AoD information refers to the AoD between the network element and the first candidate anchor UE.

As a non-limiting example, the first AoD information may indicate an AoD of 21-23 degrees between the network element and the target UE, and the one or more threshold values may indicate that the AoD between the network element and the first candidate anchor UE (second AoD information) should be at least 10 degrees larger or lower than the AoD between the network element and the target UE. In other words, in this case, if the AoD between the network element and the first candidate anchor UE is larger than 31-33 degrees or less than 11-13 degrees, then the first candidate anchor UE may determine that it is in a suitable location relative to the target UE.

Alternatively, or additionally, the determination may be based at least partly on the one or more location zones that may be defined by the target UE or by the network.

In block 608, the first candidate anchor UE may transmit an indication to the target UE to indicate whether the first candidate anchor UE is a suitable anchor UE or in the suitable location based on the determination. For example, in case the first candidate anchor UE received an anchor UE request message from the target UE, then the first candidate anchor UE may transmit a response message in response to the anchor UE request message, wherein the response message indicates whether the first candidate anchor UE is the suitable anchor UE and/or in the suitable location.

The response message may further comprise the second beam-specific downlink measurement information or the second AoD information.

In block 609, the target UE may select the first candidate anchor UE as a positioning anchor (in case the first candidate anchor UE indicated that it is in a suitable location), and the target UE may transmit an indication to the first candidate anchor UE for activating it as a positioning anchor for the target UE. If there are multiple suitable candidate anchor UEs, the target UE may select one or more of them based on its positioning requirements. If the positioning requirements are high, the target UE may activate all of the available candidate anchor UEs. Otherwise, the target UE may downselect the available candidate anchor UEs.

In block 610, in response to being selected/activated as a positioning anchor for the target UE, the first candidate anchor UE may start broadcasting one or more sidelink positioning reference signals for assisting in positioning the target UE. Alternatively, the first candidate anchor UE may autonomously start broadcasting SL-PRS in response to determining that it is in the suitable location (i.e., without being separately selected by the target UE).

In case the first candidate anchor UE transmits SL-PRS for positioning the target UE, the first candidate anchor UE may also configure the directivity of the SL-PRS based on the first beam-specific DL measurement information it receives from the target UE. This means that the first candidate anchor UE would not transmit SL PRS in all directions (in an omni-directional fashion), but rather toward the direction(s) that are defined based on the outcome of the processing of the information transmitted by the target UE. In other words, the first candidate anchor UE may transmit the one or more sidelink positioning reference signal in one or more directions, wherein the one or more directions may be based on the first set of information received from the target UE. Herein the term “direction” may refer to a spatial direction or angle.

In block 611, the second candidate anchor UE performs its own beam-specific downlink measurements, for example RSRP measurements, on one or more third beams of the network element to obtain third beam-specific downlink measurement information associated with the one or more third beams of the network element. The one or more third beams mean one or more beams that are received by the second candidate anchor UE. The one or more third beams may be part of the one or more first beams, or the one or more third beams may be different than the one or more first beams.

In block 612, the second candidate anchor UE extracts, or derives, third AoD information from the third beam-specific downlink measurement information associated with the one or more third beams of the network element. The third AoD information may be extracted by translating the different RSRP levels per beam into the direction of the transmit signal from the network element.

In block 613, the second candidate anchor UE compares the first AoD information perceived at the target UE and the third AoD information perceived at the second candidate anchor UE.

In block 614, based on the comparison of the first AoD information and the third AoD information, the second candidate anchor UE determines whether it is in a suitable location relative to the target UE and the network element for acting as a positioning anchor for the target UE.

The determination may also be based at least partly on the one or more threshold values that may be received from the target UE or from the network. For example, the second candidate anchor UE may check whether the difference on the first AoD information and the third AoD information is outside the range defined by the one or more threshold values. The first AoD information refers to the AoD between the network element and the target UE, and the third AoD information refers to the AoD between the network element and the second candidate anchor UE. Alternatively, or additionally, the determination may be based at least partly on the one or more location zones that may be defined by the target UE.

In case the second candidate anchor UE determines that it is a non-suitable anchor UE or in a non-suitable location, the second candidate anchor UE backs off from transmitting SL-PRS, and declares itself as a non-suitable anchor UEs. In this case, the second candidate anchor UE may explicitly indicate the non-suitability for example by means of a response message transmitted in response to the anchor UE request message that may be received from the target UE. Alternatively, the second candidate anchor UE may implicitly indicate, for example by not responding to the anchor UE request message that may be received from the target UE, that the second candidate anchor UE is not a suitable anchor UE and/or in a suitable location.

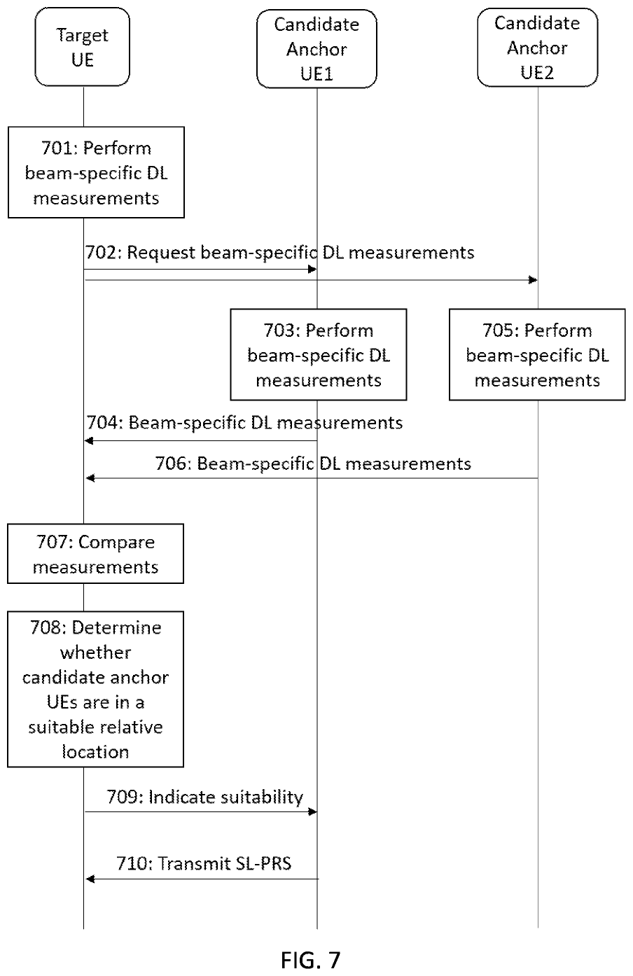

FIG. 7 illustrates a signaling diagram according to another example embodiment, wherein the selection of the anchor UEs takes place at the target UE (instead of at the candidate anchor UEs themselves). In this example embodiment, the responding candidate anchor UE may include measurements of one or more of indicated gNB/TRP beams, so that the target UE may consider those measurements in anchor UE selection with lower GDOP.

Although two candidate anchor UEs are shown in FIG. 7, it should be noted that the number candidate anchor UEs may also be different than two. In other words, there may be one or more candidate anchor UEs. In addition, the signaling procedure illustrated in FIG. 7 may be extended and applied according to the actual number of candidate anchor UEs.

Referring to FIG. 7, in block 701, the target UE performs beam-specific downlink measurements, for example RSRP measurements, on one or more first beams of a network element to obtain a first set of information associated with the one or more first beams of the network element. In other words, the first set of information may comprise first beam-specific downlink measurement information, for example RSRP measurement information, associated with the one or more first beams of the network element. The network element may be, for example, a base station such as a gNB or a TRP that is acting as a positioning anchor for the target UE. The one or more first beams mean one or more beams that are received by the target UE.

In block 702, the target UE transmits, or broadcasts, a request for beam-specific DL measurement information associated with the network element to a first candidate anchor UE and to a second candidate anchor UE via sidelink. The first candidate anchor UE and the second candidate anchor UE receive the request from the target UE via sidelink.

In block 703, the first candidate anchor UE performs its own beam-specific downlink measurements, for example RSRP measurements, on one or more second beams of the network element to obtain a second set of information associated with the one or more second beams of the network element. In other words, the second set of information may comprise second beam-specific downlink measurement information, for example RSRP measurement information, associated with the one or more second beams of the network element. The one or more second beams mean one or more beams that are received by the first candidate anchor UE. The one or more second beams may be part of the one or more first beams, or the one or more second beams may be different than the one or more first beams. The one or more first beams and the one or more second beams may be transmitted from the same network element.

In block 704, the first candidate anchor UE transmits the second set of information comprising the second beam-specific downlink measurement information to the target UE in response to the request received from the target UE.

In block 705, the second candidate anchor UE performs its own beam-specific downlink measurements, for example RSRP measurements, on one or more third beams of the network element to obtain a third set of information associated with the one or more third beams of the network element. In other words, the third set of information may comprise third beam-specific downlink measurement information, for example RSRP measurement information, associated with the one or more third beams of the network element. The one or more third beams mean one or more beams that are received by the second candidate anchor UE. The one or more third beams may be part of the one or more first beams, or the one or more third beams may be different than the one or more first beams. The one or more first beams and the one or more third beams may be transmitted from the same network element.

In block 706, the second candidate anchor UE transmits the third set of information comprising the third beam-specific downlink measurement information to the target UE in response to the request received from the target UE.

In block 707, the target UE compares the first set of information perceived at the target UE and the second set of information perceived at the first candidate anchor UE. The target UE further compares the first set of information perceived at the target UE and the third set of information perceived at the second candidate anchor UE.

For example, the target UE may infer/determine whether a given candidate anchor UE is located in the middle between the network element and the target UE (without extracting AoD information from the measurements). As a result, the target UE may estimate the level of GDOP and infer/determine whether the candidate anchor UE is in a suitable relative location to the target UE.

Alternatively, the target UE may extract, or derive, first AoD information from the first beam-specific downlink measurement information (measured by the target UE) associated with the one or more first beams of the network element. The target UE may also extract, or derive, second AoD information from the second beam-specific DL measurement information provided by the first candidate anchor UE (i.e., with respect to the same network element as the first AoD information). The target UE may also extract, or derive, third AoD information based on the third beam-specific DL measurement information provided by the second candidate anchor UE (i.e., with respect to the same network element as the first AoD information). The AoD information may be extracted by translating the different RSRP levels per beam into the direction of the transmit signal from the network element. The target UE may compare the first AoD information and the second AoD information, as well as the first AoD information and the third AoD information.

In block 708, based on the comparison of the beam-specific downlink measurement information of the target UE and that of a given candidate anchor UE, or the comparison of the AoD information of the target UE and that of a given candidate anchor UE, the target UE determines whether the candidate anchor UEs are in a suitable location relative to the target UE and the network element for acting as a positioning anchor for the target UE.

The determination may also be based at least partly on one or more pre-defined threshold values for a difference between the target UE measurements and the candidate anchor UE measurements. Alternatively, or additionally, the determination may be based at least partly on one or more pre-defined location zones.

In block 709, the target UE may transmit an indication to the first candidate anchor UE and/or to the second candidate anchor UE to indicate whether that particular candidate anchor UE is a suitable anchor UE or in a suitable location based on the determination.

In block 710, in case the target UE indicates that the first candidate anchor UE is the suitable anchor UE or in the suitable location relative to the target UE, then the first candidate anchor UE may become an anchor UE of the target UE, and the first candidate anchor UE may start broadcasting one or more sidelink positioning reference signals.

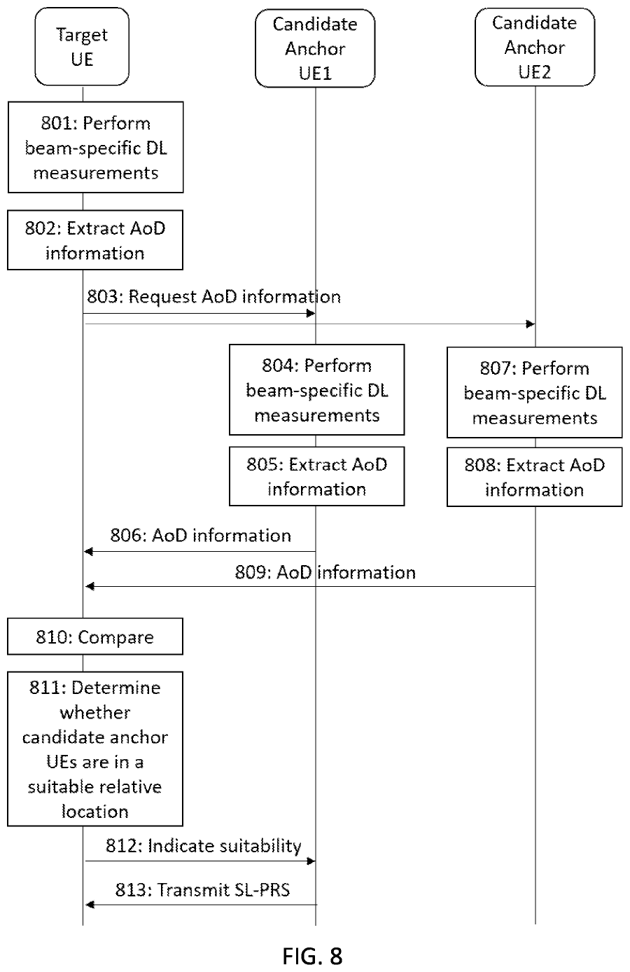

FIG. 8 illustrates a signaling diagram according to another example embodiment, wherein the selection of the anchor UEs takes place at the target UE based on AoD information received from candidate anchor UEs.

Although two candidate anchor UEs are shown in FIG. 8, it should be noted that the number candidate anchor UEs may also be different than two. In other words, there may be one or more candidate anchor UEs. In addition, the signaling procedure illustrated in FIG. 8 may be extended and applied according to the actual number of candidate anchor UEs.

Referring to FIG. 8, in block 801, the target UE performs beam-specific downlink measurements, for example RSRP measurements, on one or more first beams of a network element to obtain first beam-specific downlink measurement information, for example RSRP measurement information, associated with the one or more first beams of the network element. The network element may be, for example, a base station such as a gNB or a TRP that is acting as a positioning anchor for the target UE. The one or more first beams mean one or more beams that are received by the target UE.

In block 802, the target UE extracts, or derives, first AoD information from the first beam-specific downlink measurement information associated with the one or more first beams of the network element. The first AoD information may be extracted by translating the different RSRP levels per beam into the direction of the transmit signal from the network element.

In block 803, the target UE transmits, or broadcasts, a request for AoD information associated with the network element to a first candidate anchor UE and to a second candidate anchor UE via sidelink. The first candidate anchor UE and the second candidate anchor UE receive the request from the target UE via sidelink.

In block 804, the first candidate anchor UE performs its own beam-specific downlink measurements, for example RSRP measurements, on one or more second beams of the network element to obtain second beam-specific downlink measurement information, for example RSRP measurement information, associated with one or more second beams of the network element. The one or more second beams mean one or more beams that are received by the first candidate anchor UE. The one or more second beams may be part of the one or more first beams, or the one or more second beams may be different than the one or more first beams. The one or more first beams and the one or more second beams may be transmitted from the same network element.

In block 805, the first candidate anchor UE extracts, or derives, second AoD information from the second beam-specific downlink measurement information associated with the one or more second beams of the network element. The second AoD information may be extracted by translating the different RSRP levels per beam into the direction of the transmit signal from the network element.

In block 806, the first candidate anchor UE transmits a second set of information comprising the second AoD information to the target UE in response to the request received from the target UE.

In block 807, the second candidate anchor UE performs its own beam-specific downlink measurements, for example RSRP measurements, on one or more third beams of the network element to obtain third beam-specific downlink measurement information, for example RSRP measurement information, associated with one or more third beams of the network element. The one or more third beams mean one or more beams that are received by the second candidate anchor UE. The one or more third beams may be part of the one or more first beams, or the one or more third beams may be different than the one or more first beams.

In block 808, the first candidate anchor UE extracts, or derives, third AoD information from the third beam-specific downlink measurement information associated with the one or more third beams of the network element. The third AoD information may be extracted by translating the different RSRP levels per beam into the direction of the transmit signal from the network element.

In block 809, the second candidate anchor UE transmits a third set of information comprising the third AoD information to the target UE in response to the request received from the target UE.

In block 810, the target UE compares the first set of information (first AoD information) perceived at the target UE and the second set of information (second AoD information) perceived at the first candidate anchor UE. The target UE further compares the first set of information (first AoD information) perceived at the target UE and the third set of information (third AoD information) perceived at the second candidate anchor UE.

In block 811, based on the comparison, the target UE determines whether each of the candidate anchor UEs are a suitable anchor UE or in a suitable location relative to the target UE and the network element for acting as a positioning anchor for the target UE.

The determination may also be based at least partly on one or more pre-defined threshold values for a comparison between the target UE measurements and the candidate anchor UE measurements. Alternatively, or additionally, the determination may be based at least partly on one or more pre-defined location zones.

In block 812, the target UE may transmit an indication to the first candidate anchor UE and/or to the second candidate anchor UE to indicate whether that particular candidate anchor UE is in the suitable location based on the determination.

In block 813, in case the target UE indicates that the first candidate anchor UE is the suitable anchor UE or in the suitable location relative to the target UE, then the first candidate anchor UE may become an anchor UE of the target UE, and the first candidate anchor UE may start broadcasting one or more sidelink positioning reference signals.

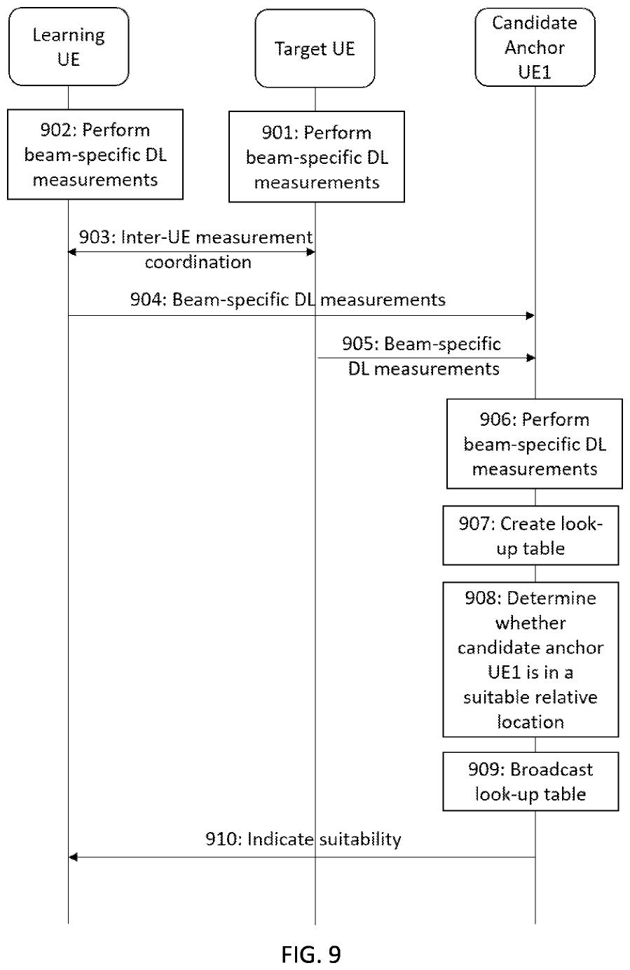

FIG. 9 illustrates a signaling diagram according to another example embodiment, wherein at least one “learning” UE can help the target UE and candidate anchor UEs to create a look-up table that is used at the anchor UEs to infer whether they are a suitable anchor UE or in a suitable location or not. The learning UE may be a “pseudo-target UE” i.e., a UE in the role of the target UE that however is not intended to localize or get localized but rather collects beam measurement data (e.g., in a drive test). In other words, the learning UE may be a user device, which is not the target UE of this positioning session, but rather conducts measurements to assist the target UE in finding the suitable anchor UEs. The learning UE may be, for example, a UE moving in parallel to the target UE (e.g., on the same highway or in the same vehicle). Thus, this “learning UE” may provide/propose information of a suitable set of anchor UEs to the target UE. This way, the target UE may skip or reduce its own beam measurement as they have already been conducted by the “learning UE”.

Although one candidate anchor UE is shown in FIG. 9, it should be noted that the number candidate anchor UEs may also be different than one. In other words, there may be one or more candidate anchor UEs. In addition, the signaling procedure illustrated in FIG. 9 may be extended and applied according to the actual number of candidate anchor UEs.

Referring to FIG. 9, in block 901, the target UE performs (at least partially) beam-specific downlink measurements, for example RSRP measurements, on one or more first beams of a network element to obtain a first set of information associated with the one or more first beams of the network element. In other words, the first set of information may comprise first beam-specific downlink measurement information, for example RSRP measurement information, associated with the one or more first beams of the network element. The network element may be, for example, a base station such as a gNB or a TRP that is acting as a positioning anchor for the target UE. The one or more first beams mean one or more beams that are received by the target UE.

In block 902, the learning UE performs (at least partially) beam-specific downlink measurements, for example RSRP measurements, on one or more fourth beams of the network element to obtain a fourth set of information associated with the one or more fourth beams of the network element. In other words, the fourth set of information may comprise fourth beam-specific downlink measurement information, for example RSRP measurement information, associated with the one or more fourth beams of the network element. The one or more fourth beams mean one or more beams that are received by the learning UE. The one or more fourth beams may be the same as the one or more first beams, or the one or more fourth beams may be different than the one or more first beams.

In block 903, the learning UE and the target UE perform inter-UE measurement coordination with each other.

In block 904, the learning UE transmits, or broadcasts, the fourth set of information comprising the fourth beam-specific DL measurement information to a first candidate anchor UE via sidelink. The first candidate anchor UE receives the fourth set of information from the learning UE via sidelink.

In block 905, the target UE transmits, or broadcasts, the first set of information comprising the first beam-specific DL measurement information to the first candidate anchor UE via sidelink. The first candidate anchor UE receives the first set of information from the target UE via sidelink.

In block 906, the first candidate anchor UE performs its own beam-specific downlink measurements, for example RSRP measurements, on one or more second beams of the network element to obtain a second set of information associated with the one or more second beams of the network element. In other words, the second set of information may comprise second beam-specific downlink measurement information, for example RSRP measurement information, associated with the one or more second beams of the network element. The one or more second beams mean one or more beams that are received by the first candidate anchor UE. The one or more second beams may be the same as the one or more first beams, or the one or more second beams may be different than the one or more first beams.

In block 907, the first candidate anchor UE creates a look-up table based at least partly on the first set of information, the second set of information, and the fourth set of information. Herein the look-up table may mean a list summarizing the decision-making inputs. The look-up table may define one or more location zones, for example exclusion and/or inclusion zones, which are absolute location zones on the basis of the target UE's absolute location and the exclusion (or inclusion) areas not favorable (or favorable) for other UEs to be selected as anchor UEs of the target UE. The look-up table may be kept as such for as long as the target UE is not sufficiently relocated. Each time there is a relocation of the target UE, the look-up table may be updated accordingly. This may be a UE-implementation action, or it may be configured by the network to follow the target UE movement.

In block 908, by using the look-up table, the first candidate anchor UE determines whether it is in a suitable location relative to the target UE and the network element for acting as a positioning anchor for the target UE.

In block 909, the first candidate anchor UE may transmit, or broadcast, the look-up table to one or more other candidate anchor UEs via sidelink. This way, the first candidate anchor UE can share the look-up table with other UE(s) via sidelink broadcast channel, such that the other UE(s) can utilize this information when creating their own look-up tables for their own exclusion (or inclusion) zones as defined above.

In block 910, the first candidate anchor UE may transmit an indication to the learning UE and/or to the target UE to indicate whether the first candidate anchor UE is in the suitable location based on the determination. The indication may be transmitted together with the look-up table, or separately from the look-up table.

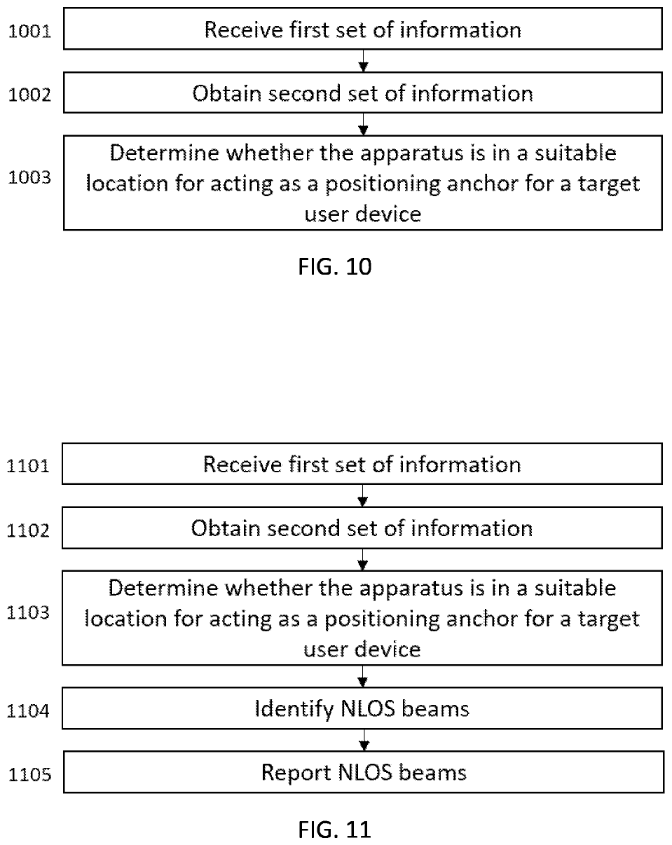

FIG. 10 illustrates a flow chart according to an example embodiment of a method performed by an apparatus such as, or comprising, or comprised in, a candidate anchor UE. The candidate anchor UE may also be called a first candidate anchor UE, a second candidate anchor UE, a candidate anchor user device or a candidate positioning anchor herein.

Referring to FIG. 10, in block 1001, a first set of information associated with one or more first beams of a network element is received. The one or more first beams may refer to one or more beams received by a target user device from the network element.

The first set of information may comprise, for example, first beam-specific downlink measurement information and/or first angle of departure information associated with the one or more first beams of the network element, as perceived at the target user device. The first beam-specific downlink measurement information may comprise any type of measurements, for example at least one of: power-based measurement, time-based measurement, angle-based measurement, and/or phase-based measurement.

In block 1002, a second set of information associated with one or more second beams of the network element is obtained by performing beam-specific downlink measurements on the one or more second beams. The one or more second beams may refer to one or more beams received by the apparatus from the network element. In other words, the one or more first beams and the one or more second beams originate from the same network element. The one or more second beams may be the same as the one or more first beams, or the one or more second beams may be different than the one or more first beams.

The second set of information may comprise, for example, second beam-specific downlink measurement information and/or second angle of departure information associated with the one or more second beams of the network element, as perceived at the apparatus. The second beam-specific downlink measurement information may comprise any type of measurements, for example at least one of: power-based measurement, time-based measurement, angle-based measurement, and/or phase-based measurement.

In block 1003, the apparatus determines, based at least partly on the first set of information and the second set of information, whether the apparatus is in a suitable location for acting as a positioning anchor for the target user device.

FIG. 11 illustrates a flow chart according to another example embodiment of a method performed by an apparatus such as, or comprising, or comprised in, a candidate anchor UE. The candidate anchor UE may also be called a first candidate anchor UE, a second candidate anchor UE, a candidate anchor user device or a candidate positioning anchor herein.

Referring to FIG. 11, in block 1101, a first set of information associated with one or more first beams of a network element is received from a target user device.

In block 1102, a second set of information associated with one or more second beams of the network element is obtained by performing beam-specific downlink measurements on the one or more second beams.

In block 1103, the apparatus determines, based at least partly on the first set of information and the second set of information, whether the apparatus is in a suitable location for acting as a positioning anchor for the target user device.

In block 1104, the apparatus identifies one or more non-line-of-sight (NLOS) beams from the one or more second beams of the network element. In other words, the apparatus may determine the set of beam(s) that have a dominant NLOS component (i.e., beams that are scattered by a reflector or scatterer or blocker), and report that set of NLOS beam(s), as NLOS measurement may deteriorate the positioning accuracy.

In block 1105, the apparatus reports the one or more non-line-of-sight beams to the target user device. The target UE may add the NLOS beam(s) to an exclusion list (and/or add the line-of-sight beams to an inclusion list), refraining from taking measurement from those NLOS beam(s) into account.

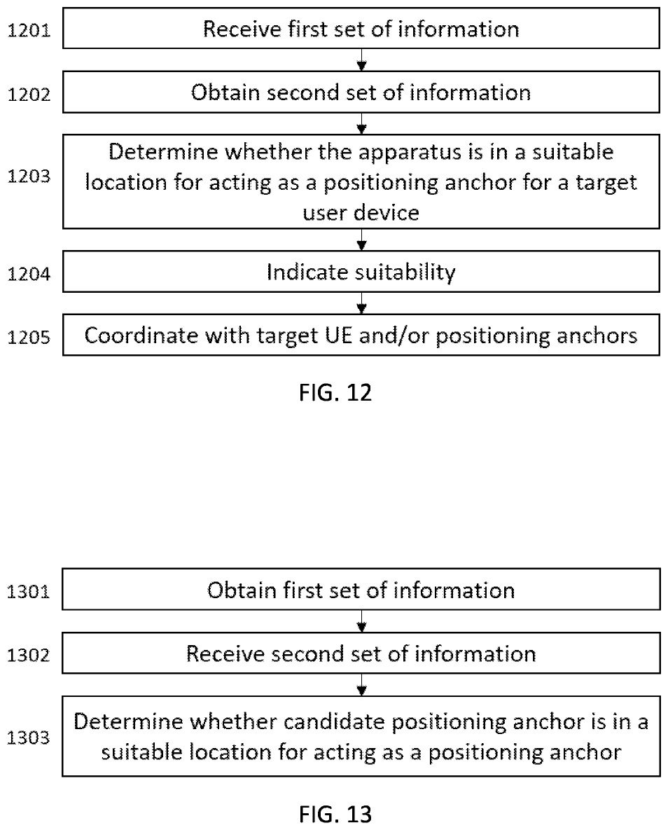

FIG. 12 illustrates a flow chart according to another example embodiment of a method performed by an apparatus such as, or comprising, or comprised in, a candidate anchor UE. The candidate anchor UE may also be called a first candidate anchor UE, a second candidate anchor UE, a candidate anchor user device or a candidate positioning anchor herein.

Referring to FIG. 12, in block 1201, a first set of information associated with one or more first beams of a network element is received from a target user device.

In block 1202, a second set of information associated with one or more second beams of the network element is obtained by performing beam-specific downlink measurements on the one or more second beams.

In block 1203, the apparatus determines, based at least partly on the first set of information and the second set of information, whether the apparatus is in a suitable location for acting as a positioning anchor for the target user device.

In block 1204, the apparatus may transmit an indication to indicate that the apparatus is in the suitable location based on the determination.

In block 1205, the apparatus coordinates with the target user device and/or one or more positioning anchors of the target user device for updating a set of positioning anchors of the target user device. In other words, the apparatus (which has been selected as a positioning anchor for the target user device based on the above process) may coordinate with one or more other positioning anchors and/or with the target UE in order to update the positioning anchors participating in the positioning session of the target user device. In this case, a newly added anchor UE serves as a positioning anchor for the target UE. Hence, with this new addition, any new candidate anchor UEs should consider, in addition to the positioning anchors of the initial process, the new anchor UE (e.g., the apparatus), when determining whether the candidate anchor UE's relative location is suitable.

FIG. 13 illustrates a flow chart according to an example embodiment of a method performed by an apparatus such as, or comprising, or comprised in, a target UE. The target UE may also be called a target user device herein.

Referring to FIG. 13, in block 1301, a first set of information associated with one or more first beams of a network element is obtained by performing beam-specific downlink measurements on the one or more first beams. The one or more first beams may refer to one or more beams received by the apparatus from the network element.

The first set of information may comprise, for example, first beam-specific downlink measurement information and/or first angle of departure information associated with the one or more first beams of the network element, as perceived at the apparatus. The first beam-specific downlink measurement information may comprise any type of measurements, for example at least one of: power-based measurement, time-based measurement, angle-based measurement, and/or phase-based measurement.

In block 1302, a second set of information associated with one or more second beams of the network element is received from a candidate positioning anchor. The one or more second beams may refer to one or more beams received by the candidate positioning anchor from the network element. In other words, the one or more first beams and the one or more second beams originate from the same network element. The one or more second beams may be the same as the one or more first beams, or the one or more second beams may be different than the one or more first beams.

The second set of information may comprise, for example, second beam-specific downlink measurement information and/or second angle of departure information associated with the one or more second beams of the network element, as perceived at the candidate positioning anchor. The second beam-specific downlink measurement information may comprise any type of measurements, for example at least one of: power-based measurement, time-based measurement, angle-based measurement, and/or phase-based measurement.

In block 1303, the apparatus determines, based at least partly on the first set of information and the second set of information, whether the candidate positioning anchor is in a suitable location for acting as a positioning anchor for the apparatus.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The blocks, related functions, and information exchanges (messages) described above by means of FIGS. 5-13 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

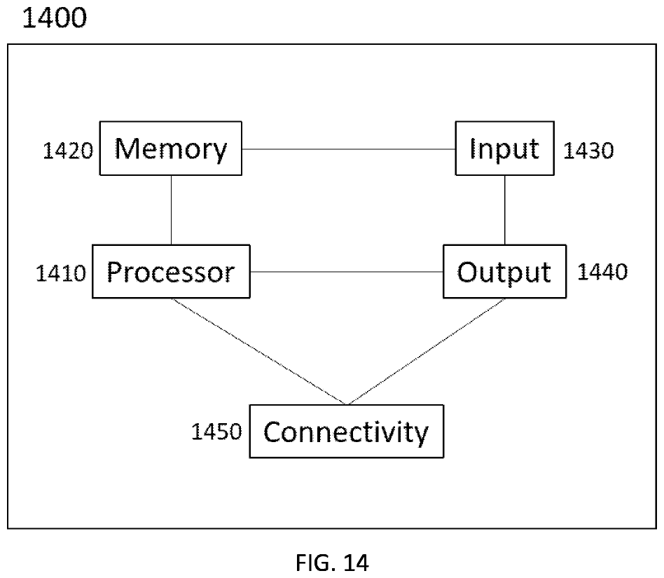

FIG. 14 illustrates an example of an apparatus 1400 comprising means for performing any of the example embodiments described above. The apparatus 1400 may be, for example, an apparatus such as, or comprising, or comprised in, a user device. The user device may also be called a target UE, a target user device, a candidate anchor UE, a first candidate anchor UE, a second candidate anchor UE, a candidate anchor user device, or a candidate positioning anchor herein.

The apparatus 1400 comprises at least one processor 1410. The at least one processor 1410 interprets computer program instructions and processes data. The at least one processor 1410 may comprise one or more programmable processors. The at least one processor 1410 may comprise programmable hardware with embedded firmware and may, alternatively or additionally, comprise one or more application-specific integrated circuits (ASICs).

The at least one processor 1410 is coupled to at least one memory 1420. The at least one processor is configured to read and write data to and from the at least one memory 1420. The at least one memory 1420 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The at least one memory 1420 stores computer readable instructions that are executed by the at least one processor 1410 to perform one or more of the example embodiments described above. For example, non-volatile memory stores the computer readable instructions, and the at least one processor 1410 executes the instructions using volatile memory for temporary storage of data and/or instructions.

The computer readable instructions may have been pre-stored to the at least one memory 1420 or, alternatively or additionally, they may be received, by the apparatus, via an electromagnetic carrier signal and/or may be copied from a physical entity such as a computer program product. Execution of the computer readable instructions by the at least one processor 1410 causes the apparatus 1400 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 1400 may further comprise, or be connected to, an input unit 1430. The input unit 1430 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1430 may comprise an interface to which external devices may connect to.

The apparatus 1400 may also comprise an output unit 1440. The output unit may comprise or be connected to one or more displays capable of rendering visual content, such as a light emitting diode (LED) display, a liquid crystal display (LCD) and/or a liquid crystal on silicon (LCoS) display. The output unit 1440 may further comprise one or more audio outputs. The one or more audio outputs may be for example loudspeakers.

The apparatus 1400 further comprises a connectivity unit 1450. The connectivity unit 1450 enables wireless connectivity to one or more external devices. The connectivity unit 1450 comprises at least one transmitter and at least one receiver that may be integrated to the apparatus 1400 or that the apparatus 1400 may be connected to. The at least one transmitter comprises at least one transmission antenna, and the at least one receiver comprises at least one receiving antenna. The connectivity unit 1450 may comprise an integrated circuit or a set of integrated circuits that provide the wireless communication capability for the apparatus 1400. Alternatively, the wireless connectivity may be a hardwired application-specific integrated circuit (ASIC). The connectivity unit 1450 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 1400 may further comprise various components not illustrated in FIG. 14. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the example embodiments.

1. An apparatus comprising at least one processor, and at least one memory storing instructions which, when executed by the at least one processor, cause the apparatus at least to:
receive a first set of information associated with one or more first beams of a network element;
obtain a second set of information associated with one or more second beams of the network element by performing beam-specific downlink measurements on the one or more second beams; and
determine, based at least partly on the first set of information and the second set of information, whether the apparatus is in a suitable location for acting as a positioning anchor for a target user device.

2. The apparatus according to claim 1, further being caused to:
transmit an indication indicating whether the apparatus is in the suitable location based on the determination.

3. The apparatus according to claim 1, wherein the first set of information comprises at least one of: first beam-specific downlink measurement information and/or first angle of departure information associated with the one or more first beams of the network element, and
wherein the second set of information comprises at least one of: second beam-specific downlink measurement information and/or second angle of departure information associated with the one or more second beams of the network element.

4. The apparatus according to claim 3, further being caused to:
extract the first angle of departure information from the first beam-specific downlink measurement information associated with the one or more first beams of the network element; and
extract the second angle of departure information from the second beam-specific downlink measurement information associated with the one or more second beams of the network element,
wherein the determination is based on comparing the first angle of departure information and the second angle of departure information.

5. The apparatus according to claim 1, further being caused to:
receive one or more threshold values for a comparison between the first set of information and the second set of information,
wherein the determination is based at least partly on the one or more threshold values.

6. The apparatus according to claim 1, further being caused to:
receive information on one or more location zones,
wherein the determination is based at least partly on the one or more location zones.

7. The apparatus according to claim 1, further being caused to:
receive a message comprising a request for a positioning anchor, wherein the message further comprises the first set of information.

8. The apparatus according to claim 7, further being caused to:
transmit a response message in response to the request, wherein the response message indicates whether the apparatus is in the suitable location, and
wherein the response message further comprises the second set of information.

9. The apparatus according to claim 1, further being caused to:
implicitly indicate that the apparatus is not in the suitable location.

10. The apparatus according to claim 1, further being caused to:
receive, from another user device, a third set of information associated with one or more third beams of the network element, wherein the third set of information comprises at least one of: third beam-specific measurement information and/or third angle of departure information,
wherein the determination is based at least partly on the third set of information.

11. The apparatus according to claim 10, further being caused to:
create a look-up table based at least partly on the first set of information, the second set of information, and the third set of information, wherein the look-up table is used to determine whether the apparatus is in the suitable location; and
transmit the look-up table.

12. The apparatus according to claim 1, further being caused to:
coordinate with the target user device and/or one or more positioning anchors of the target user device for updating a set of positioning anchors of the target user device.

13. The apparatus according to claim 1, further being caused to:
identify one or more non-line-of-sight beams from the one or more second beams of the network element; and
report the one or more non-line-of-sight beams.

14. The apparatus according to claim 1, further being caused to:
transmit one or more sidelink positioning reference signals in one or more directions, wherein the one or more directions are based on the first set of information.

15.-21. (canceled)

22. A method comprising:
receiving, by an apparatus, a first set of information associated with one or more first beams of a network element;
obtaining, by the apparatus, a second set of information associated with one or more second beams of the network element by performing beam-specific downlink measurements on the one or more second beams; and
determining, by the apparatus, based at least partly on the first set of information and the second set of information, whether the apparatus is in a suitable location for acting as a positioning anchor for a target user device.

23. The method according to claim 22, further comprising:
transmitting an indication indicating whether the apparatus is in the suitable location based on the determination.

24. The method according to claim 22, wherein the first set of information comprises at least one of: first beam-specific downlink measurement information and/or first angle of departure information associated with the one or more first beams of the network element, and
wherein the second set of information comprises at least one of: second beam-specific downlink measurement information and/or second angle of departure information associated with the one or more second beams of the network element.

25. A non-transitory computer readable medium comprising program instructions which, when executed by an apparatus, cause the apparatus to perform at least the following:
receiving a first set of information associated with one or more first beams of a network element;
obtaining a second set of information associated with one or more second beams of the network element by performing beam-specific downlink measurements on the one or more second beams; and
determining, based at least partly on the first set of information and the second set of information, whether the apparatus is in a suitable location for acting as a positioning anchor for a target user device.

26. The non-transitory computer readable medium according to claim 25, further causing the apparatus to perform:
transmitting an indication indicating whether the apparatus is in the suitable location based on the determination.

27. The non-transitory computer readable medium according to claim 25, wherein the first set of information comprises at least one of: first beam-specific downlink measurement information and/or first angle of departure information associated with the one or more first beams of the network element, and
wherein the second set of information comprises at least one of: second beam-specific downlink measurement information and/or second angle of departure information associated with the one or more second beams of the network element.
